(19) United States
(12) Patent Application Publication
(10) Pub. No.: US 2022/0248146 A1
(43) Pub. Date: Aug. 4, 2022

(54) MICRO ELECTROSTATIC SPEAKER

(71) Applicant: Waves Audio Ltd., Tel Aviv (IL)

(72) Inventors: Gabriel Zeltzer, Lapid (IL); Meir Shaashua, Tel Aviv (IL); Gavriel Speyer, Ramat Gan (IL)

(21) Appl. No.: 17/607,904

(22) PCT Filed: Apr. 30, 2020
(86) PCT No.: PCT/IL2020/050488

§ 371 Date: Nov. 1, 2021

(30) Foreign Application Priority Data
May 6, 2019 (GB) 1906361.9

(51) Int. Cl. H04R 19/02; H04R 7/04; H04R 7/18; H04R 31/00

(52) U.S. Cl. CPC H04R 19/02; H04R 7/04; H04R 2307/027; H04R 31/003; H04R 7/18

(57) ABSTRACT

An acoustic device including a membrane having an edge. A membrane support is attached to the edge of the membrane. A central region of the membrane is unsupported by the support. A first electrode and the membrane support are manufactured as a single element. The first electrode is disposed parallel to the membrane. The membrane is configured to respond acoustically to a varying first electric field emanating from the first electrode when a varying first voltage is applied to the first electrode. A coating is deposited on a surface of the first electrode facing the membrane.

### BACKGROUND

### 1. Technical Field

The present invention relates to an electrostatic audio device, particularly an electrostatic loudspeaker and/or earphone of small dimension.

### 2. Description of Related Art

In the art of high fidelity sound reproduction, the electrostatic loudspeaker has received attention because of inherent excellent sound quality and smooth response over wide frequency ranges. In such devices, a flexible sound producing membrane is positioned near an electrode, or in the case of a push-pull arrangement, a pair of electrodes, one on either side of the membrane. A direct current polarization potential is applied between the membrane and the electrodes, and an audio signal is superimposed on the electrodes, causing the membrane to move in response to the audio signal. Electrodes are acoustically transmissive so that sound produced by the moving membrane radiates outward through the electrode to the listening area.

Electrostatic speakers are highly efficient devices both electrically and mechanically. Electrical impedance is high and decreases with increasing acoustic frequency. High electrical impedance results in very low operating currents and minimal electrical losses. Mechanically, there are no moving parts other than the moving membrane which is very light in weight. Electrostatic speakers are therefore inherently more energy efficient than electrodynamic acoustic devices currently used in battery operated electronic devices.

Thus, there is a need for and it would be advantageous to have a small electrostatic speaker of high efficiency suitable for use in battery operated electronic devices.

### BRIEF SUMMARY

Various acoustic devices are disclosed herein, according to different features of the present invention. The device includes a membrane having an edge. A membrane support is attached to the edge of the membrane. A central region of the membrane is unsupported by the support. A first electrode is disposed parallel to the membrane. The membrane is configured to respond acoustically to a varying first electric field emanating from the first electrode when a varying first voltage is applied to the first electrode. A coating is deposited on a surface of the first electrode facing the membrane. The coating includes a protective layer of polymeric para-xylylene. The membrane support and the first electrode may be manufactured as a single element. A largest dimension of the acoustic device may be fifty millimetres. Thickness of the coating may be between one and twenty microns. The membrane may include a thermoplastic film with a metallic or semi-metallic material deposited on or impregnated into the thermoplastic film to produce a nanocomposite material. The first electrode may include an electrically conductive material coated with the protective layer. The first electrode may include an electrically insulating material coated with a first layer of an electrically conductive material and the first layer coated with a second layer being the protective layer. A second electrode may be disposed parallel to the membrane opposite from the first electrode. The membrane may be configured to respond mechanically to a varying second electric field emanating from the second electrode (in combination with the first electric field emanating from the first electrode) when a varying second voltage is applied to the second electrode. The first electric field and the second electrical field may constructively add when the varying first and second voltages are out of phase. A coating may be deposited on a surface of the second electrode facing the membrane. The coating may include a layer essentially of a polymeric para-xylylene. A rigid member may be attached to the membrane covering a portion of the membrane on a surface of the membrane. The rigid member may have a bending modulus greater than a bending modulus of the membrane. The first electrode may have through holes positioned according to a close packed lattice, e.g. hexagonal closed packed lattice. The holes may be configured to convey outward air flow from the moving membrane. The first electrode may have an annular shape with a central hole. The first electrode may have a maximum dimension D. The first electrode may include multiple annular shaped apertures between radii r₂ and r₁, where radius r₁ is less than radius r₂, and radius r₂ is less than half the maximum dimension D. The first electrode may have an axis of rotational symmetry intersecting a plane including a surface of the first electrode at a centre of rotation. Thickness of the first electrode measured along a line parallel to the axis of rotational symmetry near the centre of rotation may be less than a thickness of the first electrode measured along a line parallel to the axis of rotational symmetry far from the centre of rotation. The membrane support and/or first electrode may include a side exit port which is adapted to convey air flow to and from a space between the first electrode and the membrane.

Various methods are disclosed herein, according to different features of the present invention, for assembly of an acoustic device. A membrane having an edge is mounted onto a membrane support by attaching the edge of the membrane to the membrane support. The central region of the membrane is unsupported by the membrane support. A protective layer is deposited on a surface of an electrode. The protective layer includes a polymeric para-xylylene. The membrane support and the first electrode may be manufactured as a single element. The electrode is disposed parallel to the membrane with the protective layer facing the membrane. The membrane is configured to respond acoustically to a varying first electric field emanating from the electrode when a varying first voltage is applied to the electrode. A rigid member may be attached to the membrane. The rigid member may cover a portion of the membrane around a centre of the membrane. The rigid member may have a bending modulus substantially greater than a bending modulus of the membrane. A protective layer is deposited on a surface of an electrode. The electrode is assembled parallel to the membrane with the protective layer facing the membrane. The membrane is configured to respond acoustically to a varying first electric field emanating from the first electrode when a varying first voltage is applied to the electrode. An electrode with through holes may be positioned according to a close packed lattice.

### BRIEF DESCRIPTION OF THE DRAWINGS

The invention is herein described, by way of example only, with reference to the accompanying drawings, wherein:

FIG. 1 illustrates schematically in cross section, an acoustic device according to embodiments of the present invention;

FIG. 2A illustrates in cross section an electrode which may be used in the acoustic device of FIG. 1, according to embodiments of the present invention;

FIG. 2B illustrates in cross section an electrode which may be used the acoustic device of FIG. 1, according to other embodiments of the present invention;

FIG. 2C illustrates another embodiment of an acoustic device, according to embodiments of the present invention;

FIG. 3 is an exploded isometric drawing showing assembly of an acoustic device of FIG. 1, according to embodiments of the present invention;

FIG. 4 shows an isometric view of the acoustic device of FIG. 1, according to features of the present invention, fully assembled in cross section through the largest dimension.

FIG. 5 which includes an isometric view of the acoustic device of FIG. 1 as assembled, according to features of the present invention;

FIG. 6 is an isometric view of a membrane assembly, according to features of the present invention, including a tensioned membrane mounted on a support.

FIG. 7A is an isometric exploded view of a membrane assembly, according to further features of the present invention;

FIG. 7B is an isometric view of a membrane assembly including a rigid member adhering to centre of membrane, according to embodiment of FIG. 7A;

FIG. 8A illustrates an electrode with apertures placed on a two dimensional hexagonal close packed lattice, according to a feature of the present invention;

FIG. 8B illustrates an electrode with arc-shaped apertures situated on an annulus, according to a feature of the present invention;

FIG. 8C illustrates an annular shaped electrode with a hole in a centre region, according to a feature of the present invention;

FIG. 8D, is a cross sectional side view of an electrode, according to a feature of the present invention;

FIG. 8E illustrates a top view of an electrode, according to an embodiment of the present invention;

FIG. 8F illustrates a cross-sectional side view of an acoustic device, according to the embodiment of the present invention shown in FIG. 8E;

FIG. 8G illustrates a side view of an acoustic device, according to the embodiment of the invention shown in FIGS. 8E and 8F.

FIGS. 9A and 9B illustrate simplified flow diagrams of methods, according to features of the present invention.

FIG. 10A illustrates details of a membrane structure, an element of an acoustic device, according to features of the present invention;

FIG. 10B illustrates details of a membrane heterostructure, an element of an acoustic device, according to features of the present invention; and

FIG. 10C illustrates details of a membrane heterostructure, an element of an acoustic device, according to features of the present invention.

The foregoing and/or other aspects will become apparent from the following detailed description when considered in conjunction with the accompanying drawing figures.

### DETAILED DESCRIPTION

Reference will now be made in detail to features of the present invention, examples of which are illustrated in the accompanying drawings, wherein like reference numerals refer to like elements throughout. The features are described below to explain the present invention by referring to the figures.

By way of introduction, aspects of the present invention are directed to design of a small electrostatic speaker of maximum dimension, e.g. diameter D of 50 millimetres or less, or in some embodiments an electrostatic acoustic speaker of dimension D of 25 millimetres or less, or in yet other embodiments an electrostatic acoustic speaker of dimension D of 10 millimetres or less. For an earphone application, an electrostatic speaker may have maximum dimension, e.g. diameter D of 20 millimetres or less.

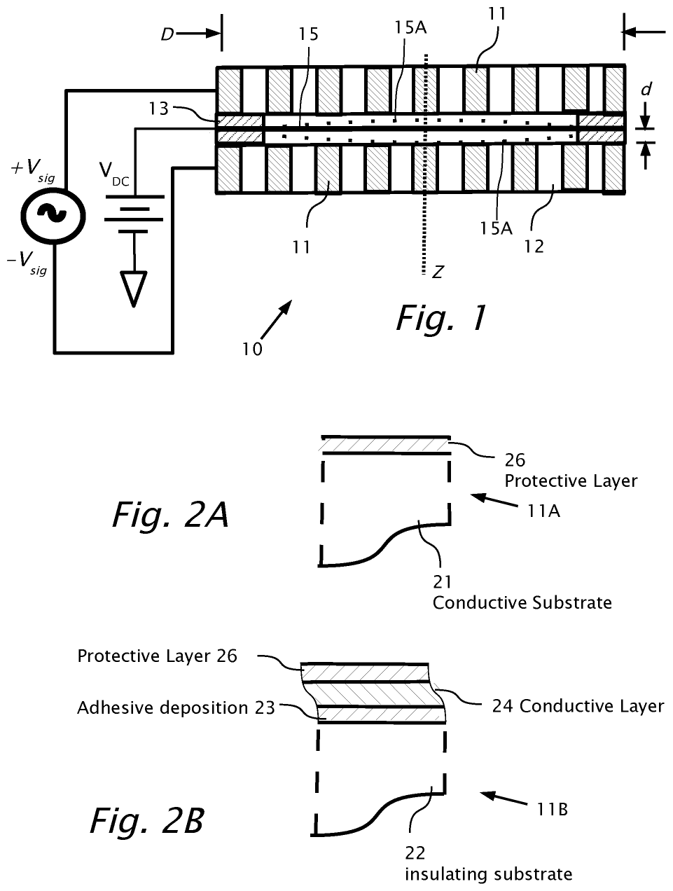

Referring now to the drawings, FIG. 1 illustrates schematically in cross section, an acoustic device or electrostatic speaker 10, according to embodiments of the present invention. A vertical axis Z is shown through a centre of electrostatic speaker 10. A membrane 15 is supported in tension by membrane supports 13, in a plane essentially perpendicular to vertical axis Z. Membrane 15 may be impregnated with a conductive, resistive and/or electrostatic material so that membrane 15 responds mechanically to a changing electric field. Two electrodes 11 are shown in FIG. 1 which are mounted in parallel to membrane 15, nominally equidistant, at a distance d, e.g. 20-500 micrometers from membrane 15. Electrodes 11 are illustrated as perforated with apertures 12 transmissive to sound waves emanating from membrane 15 when electrostatic speaker 10 is operating.

During operation of electrostatic speaker 10, a constant direct current (DC) bias voltage, e.g. +V_{DC}=+1000 volts, may be applied using a conductive contact to membrane 15. Voltage signals ±V_{sig} may be applied to electrodes 11. Voltage signals ±V_{sig} vary at audio frequencies, nominally between 20-20,000 Hertz. A non-inverted voltage signal +V_{sig} may be applied to one of electrodes 11 and an identical but inverted voltage signal −V_{sig} may be applied to the other electrode 11. Dotted lines 15A illustrate schematically membrane 15 moving in response to a changing electric voltage due to voltage signals ±V_{sig}.

A force F_{sig} on membrane 15 responsive to voltage signals ±V_{sig} may be approximated or modelled by equation (1):

$${F}_{sig} = 2 {ɛ}_{0} \cdot A \frac{\vert ( {V}_{DC} ) \vert}{{d}^{2}} \cdot \vert ( {V}_{sig} ) \vert \qquad ( 1 )$$

where A is the nominal surface area of electrostatic speaker 10, and ε₀ is the electrical constant, or permittivity of free space nominally equal to 8.85×10⁻¹² farads/meter.

The sound pressure level (SPL) may be measured at a particular distance, e.g. 0.5 meter, along axis Z from an electrostatic speaker and is generally proportional to force F_{sig} on membrane 15 due to the voltage signals ±V_{sig}, V_{DC} and further dependent on mechanical modes of oscillation.

According to features of the present invention, the maximum dimension, e.g. diameter D of electrostatic speaker 10 is less than 50 millimetres or in other embodiments, dimension, e.g. diameter D, of electrostatic speaker 10 is less than 25 millimetres, or dimension D, of electrostatic speaker 10 is less than 10 millimetres. In yet other embodiments, such as when used for a earphones, acoustic device 10 may have a maximum dimension D of 20 millimetres. According to equation (1) sound pressure level (SPL) is expected to generally decrease with decreasing area of electrostatic speaker 10 and SPL is expected to generally decrease with decreasing voltages V_{DC} and ±V_{sig}. In order to compensate for the smaller area A, and maintain a specific pressure level (SPL), a larger DC constant bias voltage V_{DC}, a larger absolute value signal voltage ±V_{sig} and/or smaller distance d between electrodes 11 and membrane 15 may be required to maintain a required sound pressure level (SPL).

However, as distance d decreases, or as DC bias voltage +V_{DC} and/or signal voltages ±V_{sig} increase (in absolute value) then there is an increased chance for a short circuit between membrane 15 and electrode 11 and/or dielectric breakdown of air which is expected nominally at about 3×10⁶ Volt/meter. Assuming an average DC voltage V_{DC} on membrane 15 of 800 volts, electrical breakdown may occur with distance d of 200-300 micrometers.

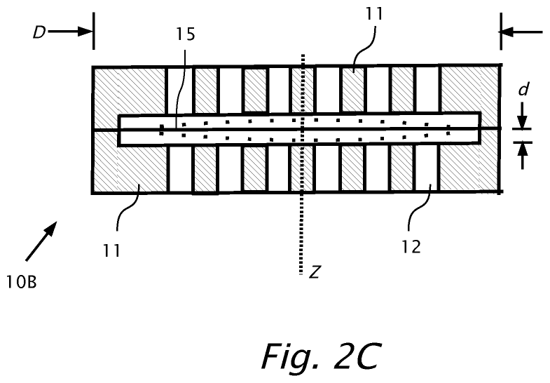

Reference is now made to FIGS. 2A and 2B, according to further features of the present invention, which illustrate schematically electrode 11, configured to minimize or avoid the aforementioned problem of electrical breakdown. FIG. 2A illustrates schematically an electrode 11A which may be used in electrostatic speaker 10 as electrode 11 as shown in FIG. 1. Electrode 11A includes an electrically conductive substrate 21 coated with a protective layer 26. Electrode 11A may be mounted in electrostatic speaker 10 so that protective layer 26 faces membrane 15. Protective layer 26 is configured to improve the dielectric strength of the dielectric gap, air and protective layer 26, between electrode 11 and membrane 15.

FIG. 2B illustrates schematically an electrode 11B which may be used in electrostatic speaker 10 as electrode 11 in FIG. 1, according to other embodiments of the present invention. Electrode 11B includes an electrically insulating substrate 22 coated with a conductive layer 24 and then coated with protective layer 26. Conductive substrate 21 or conductive layer 24 may be essentially metallic including: titanium, palladium, platinum, gold, silver, aluminium, copper, iron, tin, bronze, brass and steel, by way of example.

As in electrode 11A, (FIG. 2A), electrode 11B is mounted in electrostatic speaker 10 as electrode 11 (FIG. 1) so that protective layer 26 faces membrane 15. Protective layer 26 on electrode 11B is also configured to improve the dielectric strength of the dielectric/air gap between electrode 11 and membrane 15. Electrically insulating substrate 22 may be quartz, silica, glass, sapphire, alumina, and/or a thermoplastic material such as polyetherimide (PEI); polyether ether ketone (PEEK) thermoplastic polymer or other thermoplastic in the polyaryletherketone (PAEK) family, Vespel™ a polyimide-based plastics manufactured by DuPont™, by way of example. Protective layer 26 may include polymeric materials such as urethane, silicone, epoxy, acrylic, polypropylene, polytetrafluoroethylene (PTFE), polyimide and/or a fluoropolymer such as 3M™ FPE, by way of example. Protective layer 26 thickness may be one to twenty microns thick. Alternatively, protective layer 26 thickness may be five to ten microns thick

Protective layer 26, used for electrode 11A and electrode 11B may be a Parylene™ which is a trade name for a variety of chemical vapor deposited poly(para-xylylene) polymers. Other materials which may be suitable for protective layer 26 may include: silica, quartz, alumina, titania, and diamond.

Reference is now made to FIG. 2C, which illustrates an acoustic device 10B, according to an alternative embodiment of the present invention. Vertical axis Z is shown through a centre of acoustic device 10B. Tensioned membrane 15 is supported, by edges of electrodes 11B, in a plane essentially perpendicular to vertical axis Z. The central region of electrodes 11 are mounted in parallel to membrane 15, nominally equidistant, at a distance d, e.g. 50-500 micrometers from membrane 15. Electrodes 11 are illustrated as perforated with apertures 12 transmissive to sound waves emanating from membrane 15 when electrostatic speaker 10 is operating. Thus, in acoustic device 10B, electrodes 11 have additional functionality and support tensioned membrane including the function of membrane support 13 in acoustic device 10, (FIG. 1). Acoustic device 10B is advantageous over acoustic device 10 because membrane support 13 is not required. Acoustic device 10 has an advantage over acoustic device 10B because membrane support 13 facilitates membrane 15 replacement.

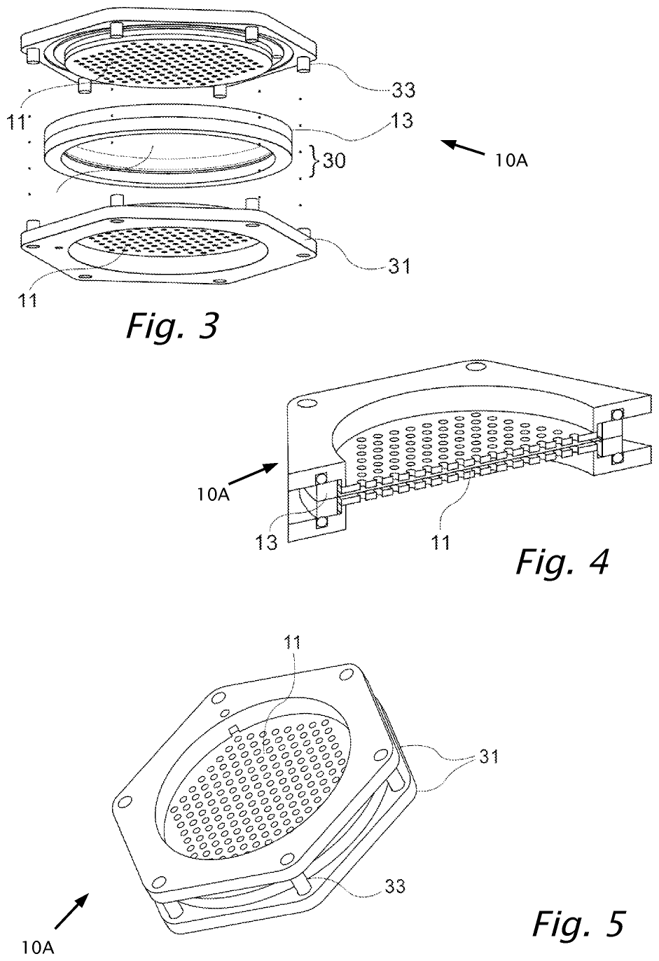

Reference is now made to FIG. 3 which is an exploded isometric drawing showing assembly of acoustic device 10. Reference is now also made to FIG. 4 which shows device 10 fully assembled in cross section through the largest dimension. Reference is now also made to FIG. 5 which includes an isometric view of acoustic device 10 as assembled. In the centre of device 10, one of membrane supports 13 is attached to perimeter or edge of membrane 15 which is shown as membrane assembly 30. The centre of membrane 15 is free to vibrate damped by surrounding air. Electrodes 11 with a surface previously coated are shown with protective layer 26 (not shown in FIGS. 3-5) facing membrane 15 when assembled. Frame 31 and spacers 33 hold assembly together with fixed distance d between electrodes 11 and membrane 15. In an embodiment of the present invention, rare earth magnets may be used as spacers 33 enabling easy disassembly and replacement of membrane assembly 30 or coated electrodes 11.

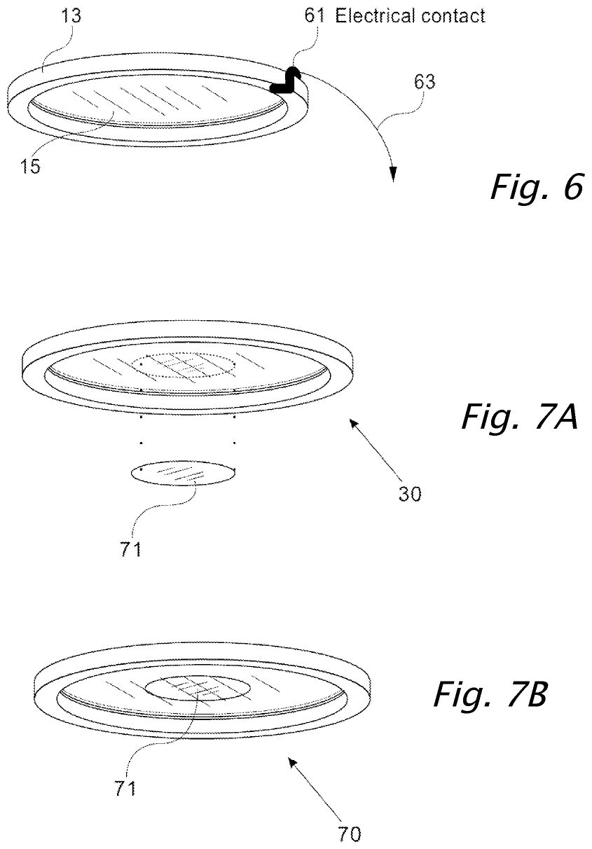

Reference is now made to FIG. 6 which shows in further detail, membrane assembly 30, according to features of the present invention, including tensioned membrane 15 mounted in tension on support 13. Membrane 15 may be configured from metal, semimetal, and/or semiconductor nano-particles or micro-particles dispersed in a matrix of a thermoplastic film of sufficient strength and elasticity. Otherwise, metal, semimetal or semiconductor material may be deposited onto the thermoplastic film using a known deposition technique such as high vacuum evaporation or sputtering. The deposition may form a thin layer which is not necessarily a contiguous layer on the thermoplastic film. Atoms or islands after deposition may form a microcomposite or nanocomposite material in which the atoms or the islands of the metal/semimetal/semiconductor infiltrate the thermoplastic matrix. The metal/semimetal/semiconductor may be selected from: gold, platinum, palladium, carbon as graphene or graphite, germanium and silicon, by way of example. The impregnated film may have a high surface resistance. The thermoplastic may be e.g. polyvinylidene fluoride (PVDF), polyetherimide (PEI), poly (phenylene sulphide) (PPS), polyetheretherketone (PEEK), polyaryletherketone (PAEK) and polyether ketone (PEK), polysulfone (PSU), poly(ethersulfone) (PES), poly(phenylene sulphide) (PPS) by way of example.

Still referring to FIG. 6, before assembly of membrane assembly 30, electrical contact 61 to membrane 15 may be facilitated by previously coating membrane support 13 with a conductive coating, at least on a surface contacting membrane 15. Copper foil or other electrically conductive material may be used to locally wrap membrane support 13 to form electrical contact 61. Other known methods for attaching membrane may include use of conductive adhesive. A wire 63, attached to electrical contact 61 is used to connect membrane 15 to bias voltage V_{DC} (FIG. 1).

Reference is now made to FIGS. 7A and 7B which illustrate membrane assembly 30, according to further features of the present invention. FIG. 7A is an exploded view of membrane assembly 30 with a further assembly on the membrane of a rigid member 71 in a centre region of membrane 15. Rigid member 71 may have a bend modulus significantly greater than a bend modulus of the membrane 15. Thickness of rigid member 71 may be 1-100 microns. Largest dimension of rigid member is 0.25-0.5 of maximum dimension, e.g. diameter of membrane assembly 70. Rigid member 71 may be of material quartz, silica, glass, sapphire or alumina, by way of example. FIG. 7B illustrates membrane assembly 70 including rigid member 71 adhering to centre of membrane 15. In addition to changing the acoustic modal properties of vibrating membrane 15 in membrane assembly 30, membrane assembly 70 may have improved dielectric strength. In addition, rigid member 71 may limit the mechanical amplitude of vibrating membrane 15 at the centre of membrane 15, and may improve lifetime by reducing electrical discharge during operation.

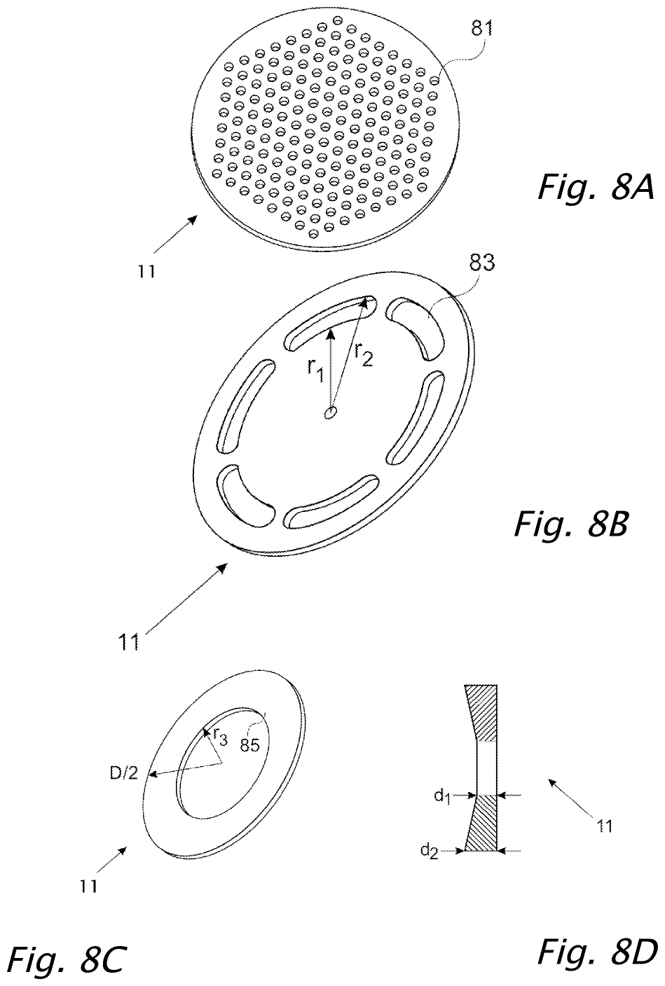

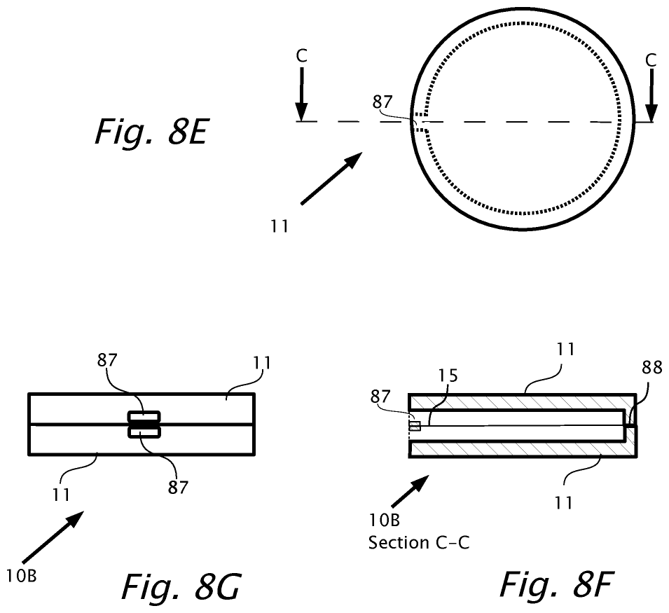

Reference is now made to FIGS. 8A, 8B, 8C, 8D and 8E, which illustrate various features or attributes of electrode 11. A FIG. 8A illustrates an electrode 11A with apertures placed on a two dimensional hexagonal close packed lattice. The apertures are preferably drilled round holes (as shown) or otherwise formed prior to deposition of protective layer 26. The corners at the surface of the apertures are preferably round or bevelled. The total area of the holes includes 30%-80% of the total surface area of electrode 11A.

FIG. 8B illustrates an electrode 11B with arc-shaped apertures 83 which are situated on an annulus between radii r₂ and r₁. Six arc-shaped apertures 83 are shown in electrode 11B. Electrode 11B as shown in FIG. 8B, is 6-fold rotationally symmetric. Generally, electrode 11B may be produced with N arc-shaped apertures 83 with N fold rotational symmetry dependent on the radii r₂ and r₁.

FIG. 8C illustrates an annular shaped electrode 11C with a hole 85 in a centre region of radius r₃ less than radius D/2 where D is diameter of electrode 11C. Central hole 85 may reduce a possibility of electrical discharge in the centre of membrane 15 where membrane 15 is least constrained.

FIG. 8D is a side view of an electrode 11, according to a feature of the present invention. Electrode 11 illustrates a central portion bevelled so that the thickness d₂ near the perimeter of electrode 11 is greater than thickness d₁ near the centre of electrode 11.

FIG. 8E illustrates a top view of an electrode 11, according to an embodiment of the present invention. Electrode 11 as shown in FIG. 8E includes a side exit port 87 a feature of the present invention. Reference is now also made to FIGS. 8F and 8G which further illustrate side exit port 87. FIG. 8F illustrates a cross-sectional side view of an acoustic device 10B, including electrodes 11 as shown in cross section through plane C as marked in FIG. 8E. In acoustic device 10B as shown in FIG. 8F, membrane 15 is supported by a lip 88 at the perimeter of electrodes 11. One or more side exit ports 87 may convey air flow responsive to the vibrating membrane 15. FIG. 8G illustrates a side view of acoustic device 10B with side exit ports 87 for air flow and sound transmission from vibrating membrane 15.

The features illustrated in FIGS. 8A-8E may be combined in various ways, according to different embodiments of the present invention. An electrode may include any of: apertures placed on a two dimensional hexagonal close packed lattice, as shown in FIG. 8A, arc-shaped apertures as shown in FIG. 8B a central hole as illustrated in FIG. 8C and/or a bevel as shown in FIG. 8D. In addition, acoustic device 10 may include side exit port 87, and optionally with or without apertures on the top face of electrodes 11

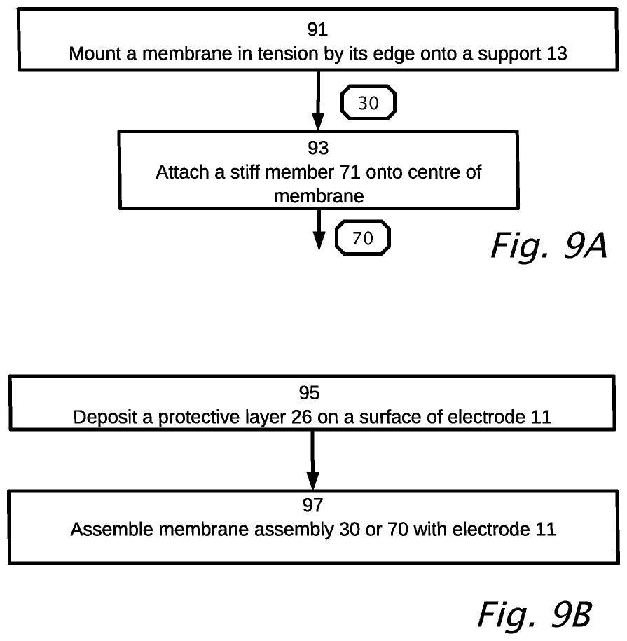

Reference is now made to FIGS. 9A and 9B which are simplified flow diagrams of methods according to features of the present invention. Referring to FIG. 9A, a membrane 15 is mounted (step 91) in tension by its edge onto a membrane support 13. A membrane assembly 30 is produced. In step 93, a rigid member 71 is attached to a surface, e.g. near the centre of membrane 15 to produce membrane assembly 70. Referring now to FIG. 9B, a protective layer is deposited (step 95) on a surface of electrode 11. Either membrane assembly 30 or membrane assembly 70 may be assembled (step 97) with electrode 11 to produce acoustic device 10.

### Membrane Hetero-Structures

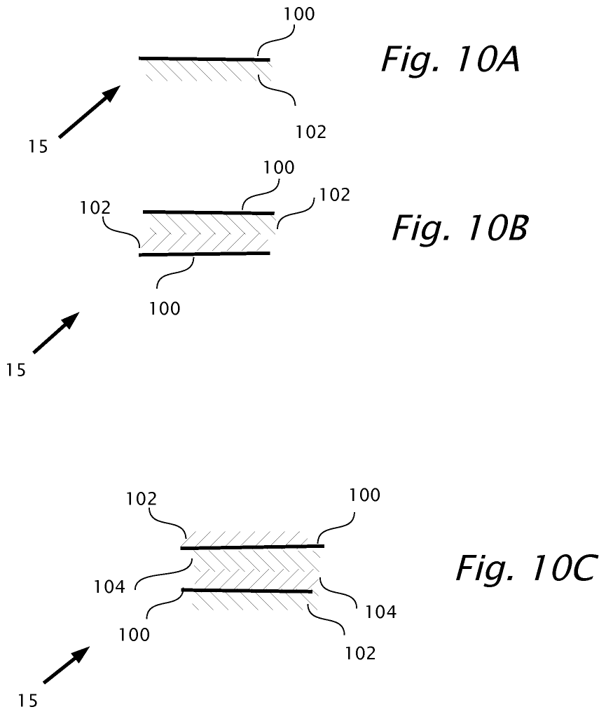

Reference is now made to FIGS. 10A, 10B and 10C which illustrate various membrane hetero-structures which may be used for membrane 15. FIG. 10A illustrates membrane 15 structure with a metallic or semi-metallic deposition on a polymer layer 102. Membrane 15 structure of FIG. 10A may be produced by first depositing the metallic or semi-metallic material on a metal, e.g. copper, foil (or other substrate) using a deposition process such as electron beam evaporation, sputtering or chemical vapor deposition (CVD) process. Polymer, e.g. thermoplastic layer 102 may be formed on metallic or semi-metallic deposition 100 by spin coating, spray coating, or solvent casting process to form a two layer coating a surface of the metal foil substrate. Conductive adhesive may be applied to a surface of membrane support 13 (or electrode 11 in the embodiment shown in FIG. 2C). Membrane 15 under appropriate tension is adhered to membrane support 13 with metallic or semimetallic deposition contacting the adhesive to membrane support 13 or electrode 11. The metal foil (or other substrate) may be etched away using a known chemical etch process to produce membrane 15 structure shown in FIG. 10A with semi-metallic or metallic deposition 100 adjacent to polymer layer 102.

Referring now to FIG. 10B which illustrates a symmetric membrane hetero-structure 15 including two metallic or semi-metallic depositions 100 on the outside and polymer, e.g. thermoplastic layer(s) on the inside. Membrane hetero-structure 15 of FIG. 10B may be produced by first depositing the metallic or semi-metallic material on a metal, e.g. copper, foil (or other substrate) using a deposition process such as electron beam evaporation, sputtering or chemical vapor deposition (CVD) process. Polymer, e.g. thermoplastic layer 102 may be formed on metallic or semi-metallic deposition 100 by spin coating, spray coating, or solvent casting process to form a two layer coating a surface of the metal foil substrate. Two such structures may be pressed together under appropriate temperature and pressure conditions with thermoplastic layers 102 on the inside so that layers 102 adhere to each either. Conductive adhesive may be applied to surfaces of membrane supports 13 (or electrode 11 in the embodiment shown in FIG. 2C). Membrane 15 under appropriate tension is adhered to membrane supports 13 with the metal foil contacting the adhesive to membrane supports 13 on both sides. The metal foils may be etched away using a known chemical etch process to produce membrane 15 structure shown in FIG. 10B with two semi-metallic or metallic depositions 100 on the outside and the two thermoplastic layers fused on the inside.

Reference is now made to FIG. 10C which illustrates a symmetric membrane hetero-structure 15 including two internal metallic or semi-metallic depositions 100 and two polymer, e.g. thermoplastic outer layers 102. Between metallic or semi-metallic depositions 100 is a polymer layer 104, e.g. thermoset polymer such as a silicone polymer. A process for producing membrane hetero-structure 15 (FIG. 10C) includes first depositing the metallic or semi-metallic material on a metal, e.g. copper, foil (or other substrate) using a deposition process such as electron beam evaporation, sputtering or chemical vapor deposition (CVD). The metallic or semi-metallic deposition may be spray or spin coated with a silicone resin by way of example, to produce layer 104. Two such structures may be pressed together prior to final cure or with additional resin on the inside so that layers 104 adhere to each either. Membrane 15 under appropriate tension is adhered to membrane supports 13 with metal foil contacting the adhesive to membrane supports 13 on both sides. The metal foil (or other substrate) on both sides may be etched away using a known chemical etch process to expose metallic or semi-metallic depositions 100. Thermoplastic layers 102 may be spray or spin coated onto metallic or semi-metallic depositions 100.

The term “nanocomposite” as used herein refers to a multi-component and/or multi-phase solid material in which one or more of the components or phases is of dimension less than 100 nanometres. The term “polymer-matrix nanocomposite refers to a nanocomposite with a matrix material being a polymer.

The term “semi-metal” or “semi-metallic as used herein refers to a material with a very small overlap between the bottom of the conduction band and the top of the valence band. Semi-metals include arsenic, antimony, bismuth, α-tin (grey tin), graphite, graphene and other forms of carbon, alkaline earth metals including: beryllium (Be), magnesium (Mg), calcium (Ca), strontium (Sr), barium (Ba), and radium (Ra) and some compounds such as mercury telluride.

The term “thermoset” as used herein in a plastic polymer that is irreversibly hardened by curing from a viscous resin. Curing may be induced by heat or radiation and results in a chemical reaction that cross-links between polymer chains to produce insoluble polymer network which does not melt on heating.

The term “thermoplastic” as used herein is a plastic polymer, which becomes soft when heated and hard when cooled. Thermoplastics when heated, melt into a liquid state.

The term “polymeric para-xylylene” or “poly(para-xylylene)” as used herein refers to a chemical vapor deposited protective layer including: poly(tetraflouro-para-xylylene), poly(monochloro-para-xylylene), poly(dichloro-para-xylylene), poly(methyl-para-xylylene), poly(ethyl-para-xylylene), siloxane substituted poly(para-xylylene), supramolecular poly(para-xylylene), poly(para-xylylene tetra sulphide), and (2,2) paracyclophane.

The term “centre” or “central region” as used herein refers to a portion of an acoustic membrane excluding its perimeter and measures between 80%-90% radially from a centre of the acoustic membrane toward the perimeter of the acoustic membrane.

The term “edge” as used herein refers to a portion of an acoustic membrane excluding the centre.

The term “bending modulus” is an intensive property of a material that is computed as the ratio of stress to strain in flexural deformation, or the tendency for a material to resist bending. Bending modulus may be determined in bulk materials from the slope of a stress-strain curve produced by a flexural test (such as the ASTM D790), and uses units of force per area.

The term “antiphase” or “out of phase” as used herein refers a varying signal 180 degrees out of phase or inverted in sign.

The term “constructively add” as used herein refers to a vector sum of two vectors in which the amplitude of the summed vector, e.g. electrical field, essentially equals the arithmetic sum of the amplitudes of the vectors being summed.

The term “dimension” D as used herein refers to the largest diagonal of a polygon of 2n vertices, where n as an integer greater than 1. For a polygon of 2n+1 vertices, where n is an integer greater than 0, the term “dimension” as used herein refers to the largest distance along a line which bisects an edge of the polygon to the opposite vertex. The term “dimension” as used herein for an ellipse is the length of the major axis which bisects the ellipse. For a circle, the term “dimension” as used herein is the diameter.

The term “acoustic device” as used herein and refers to an electrostatic speaker and/or earphone acoustic device.

The term “acoustically” refers to a mechanical response at audio frequencies, nominally between 20-20,000 Hertz.

The term “close packed” as used herein refers to a two dimensional lattice of holes with a centre hole surrounded by six holes in a plane. The centres of the six holes may form a regular hexagon.

The transitional term “comprising” as used herein is synonymous with “including”, and is inclusive or open-ended and does not exclude additional element or method steps not explicitly recited. The articles “a”, “an” is used herein, such as “a layer” or “an electrode” have the meaning of “one or more” that is “one or more layers”, “one or more electrodes”.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

Although selected features of the present invention have been shown and described, it is to be understood the present invention is not limited to the described features.

1. An acoustic device comprising:
a membrane having an edge;
a membrane support attached to the edge of the membrane, wherein a central region of the membrane is unsupported by the support;
a first electrode, wherein the membrane support and the first electrode are manufactured as a single element, the first electrode disposed parallel to the membrane, wherein the membrane is configured to respond mechanically to a varying first electric field emanating from the first electrode when a varying first voltage is applied to the first electrode; and
a coating deposited on a surface of the first electrode facing the membrane.

2. The acoustic device of claim 1, wherein the coating includes a protective layer of polymeric para-xylylene.

3. The acoustic device of claim 1, wherein a largest dimension of the acoustic device is fifty millimetres or less.

4. The acoustic device of claim 1, wherein thickness of the coating is between one and twenty microns.

5. The acoustic device of claim 1, wherein the membrane includes a thermoplastic film with a metallic or semi-metallic material deposited on or impregnated into the thermoplastic film.

6. The acoustic device of claim 2, wherein the first electrode includes an electrically conductive material coated with the protective layer.

7. The acoustic device of claim 2, wherein the first electrode includes an electrically insulating material coated with a first layer of an electrically conductive material and the first layer coated with a second layer being the protective layer.

8. The acoustic device of claim 1, further comprising:
a second electrode disposed parallel to the membrane opposite from the first electrode; wherein the membrane is configured to respond mechanically to a varying second electric field emanating from the second electrode when a varying second voltage is applied to the second electrode, wherein a coating is deposited on a surface of the second electrode facing the membrane, the coating including a protective layer.

9. The acoustic device of claim 1, further comprising:
a rigid member attached to the membrane covering a portion of the membrane on a surface of the membrane, wherein the rigid member has a bending modulus greater than a bending modulus of the membrane.

10. The acoustic device of claim 1, wherein the first electrode has through holes positioned according to a close packed lattice, wherein the holes are configured to convey outward air flow from the moving membrane.

11. The acoustic device of claim 1, wherein the first electrode has an annular shape with a central hole.

12. The acoustic device of claim 1, wherein the first electrode has a maximum dimension D, and wherein the first electrode includes a plurality of annular shaped apertures between radii r2 and r1, wherein radius r1 is less than radius r2, and wherein radius r2 is less than half the maximum dimension D.

13. The acoustic device of claim 1, wherein the first electrode has an axis of rotational symmetry intersecting a plane including a surface of the first electrode at a centre of rotation, wherein thickness of the first electrode measured along a line parallel to the axis of rotational symmetry near the centre of rotation is less than a thickness of the first electrode measured along a line parallel to the axis of rotational symmetry far from the centre of rotation.

14. The acoustic device of claim 1, wherein at least one of the membrane support and the first electrode includes a side exit port which is adapted to convey air flow to and from a space between the first electrode and the membrane.

15. The acoustic device of claim 14, wherein the first electrode is without through holes.

16. The acoustic device of claim 15, further comprising:
a second electrode disposed parallel to the membrane opposite from the first electrode; wherein the membrane is configured to respond mechanically to a varying second electric field emanating from the second electrode when a varying second voltage is applied to the second electrode, wherein the second electrode has through holes positioned according to a close packed lattice, wherein the holes are configured to convey outward air flow from the moving membrane.

17. A method for assembly of an acoustic device, the method comprising:
manufacturing a membrane support and a first electrode as a single element;
mounting a membrane having an edge onto the membrane support by attaching the edge of the membrane to the membrane support, wherein a central region of the membrane is unsupported by the membrane support;
depositing a protective layer on a surface of a first electrode;
assembling the first electrode disposed substantially parallel to the membrane; with the protective layer facing the membrane, wherein the membrane is configured to respond mechanically to a varying first electric field emanating from the first electrode when a varying first voltage is applied to the electrode.

18. The method of claim 17, further comprising:
wherein the protective layer includes a polymeric para-xylylene.
